(19) United States
(12) Patent Application Publication
(10) Pub. No.: US 2009/0102135 A1
(43) Pub. Date: Apr. 23, 2009

(54) Front cover of manual rotary pump

(76) Inventor: Tsun-Sheng Chen, Taichung (TW)

Correspondence Address: SAM CHEN, 7F-1, 293, ROOSEVELT ROAD, SEC 3, TAIPEI, TW

(21) Appl. No.: 11/876,768

(22) Filed: Oct. 22, 2007

(51) Int. Cl. F16J 15/54

(52) U.S. Cl. 277/504

(57) ABSTRACT

A front cover of a manual rotary pump includes a disk having a cavity eccentrically defined therein for airtightly receiving an oil seal. A through hole is defined in a bottom of the cavity to allow an input shaft of a rotor extending through the disk. The oil seal is airtightly sleeved on the input shaft for forming an airtight condition between the input shaft and the disk. The disk has at least two bores defined therein and longitudinally communicating with the cavity for operator to easily detach and replace the oil seal by using a tool extending through the at least two bores. A diameter of the through hole in the disk is slightly greater than that of the input shaft and the diameter difference between the through hole and the input shaft is ranged from 0.05 mm to 0.2 mm.

### BACKGROUND OF THE INVENTION

1. Field of the Invention

The present invention relates to a front cover, and more particularly to a front cover of a manual rotary pump.

2. Description of Related Art

An ordinary manual rotary pump with a conventional front caver in accordance with the prior art shown in FIGS. 5-7 comprises a hollow casing (50) having an inlet tube (51) for inserting into a container that contains liquid and an outlet tube (52) respectively longitudinally mounted to the casing (50). A rear cover (60) and a front cover (70) respectively airtightly mounted to opposite sides of the casing (50) for closing the casing (50). The front cover (70) has a through hole (71) eccentrically defined therein. A rotor (80) is rotatably mounted in the casing (50). The rotor (80) has an input shaft (81) centrally and longitudinally extending therefrom and extending through the through hole (71) in the front cover (70). An oil seal (72) is airtightly sleeved on the input shaft (81) for forming an airtight condition between the input shaft (81) and the front cover (70). A rocker arm (90) is mounted to a free end of the input shaft (81) after the input shaft (81) extending through the front cover (70) such that the pump will draw the liquid from the container via the inlet tube (51) and drain the liquid via the outlet tube (52) when operating the rocker arm (90).

With reference to FIGS. 7 and 8, in the field of manual rotary pump, the oil seal (72) is a consumable. Consequently, the oil seal (72) needs to be frequently replaced for preventing a leakage between the oil seal (72) and the input shaft (81). The diameter of the through hole (71) is installed to be greater than that of the input shaft (81) for user to easily replace the oil seal (72) because the oil seal (72) tightly abuts against the front cover (70). To the conventional front cover (70), the diameter difference between the through hole (71) and the input shaft (81) is ranged from 1.5 mm to 2.5 mm. In other words, the diameter difference between a central hole (721) in the oil seal (72) and the through hole (71) is ranged from 1.5 mm to 2.5 mm, too. Consequently, the operator can detach the oil seal (72) by using a tool or his/her finger through the through hole (71) after detaching the front cover (70) with the oil seal (72) from the casing (50).

As described above, the diameter difference between the through hole (71) and the input shaft (81) is ranged from 1.5 mm to 2.5 mm such that an annular interval (700) is formed between the input shaft (81) and the periphery of the through hole (71) after the manual rotary pump being assembled and the interval (700) is ranged from 0.75 mm to 1.25 mm, that is, the concentricity between input shaft (81) and the front cover (70) is maintained only by the oil seal (72). However, the rocker arm (90) is manual and human can continually equally rock the rocker arm (90) for rotating the rotor (80) such that the input shaft (81) is inevitably slightly shaken during being operated and the shaken input shaft (81) will non-directionally compress the oil seal (72). As a result, the oil seal (72) is easily to be deformed and forms a leakage as time passes.

The present invention has arisen to mitigate and/or obviate the disadvantage of the conventional front cover of a manual rotary pump.

### SUMMARY OF THE INVENTION

The main objective of the present invention is to provide an improved front cover of a manual rotary pump that can lengthen the use life of the oil seal in the front cover.

To achieve the objective, the front cover in accordance with the present invention comprises a disk having a cavity eccentrically defined therein for airtightly receiving an oil seal. A through hole is defined in a bottom of the cavity to allow an input shaft of a rotor extending through the disk. The oil seal is airtightly sleeved on the input shaft for forming an airtight condition between the input shaft and the disk. The disk has at least two bores defined therein and longitudinally communicating with the cavity for operator to easily detach and replace the oil seal by using a tool extending through the at least two bores. A diameter of the through hole in the disk is slightly greater than that of the input shaft and the diameter difference between the through hole and the input shaft is ranged from 0.05 mm to 0.2 mm.

The non-directional pressure from the shaken input shaft forces the inner periphery of the through hole in the disk because the interval between the input shaft and the inner periphery of the through hole is slight. Consequently, the non-directional pressure never forces the oil seal till the inner periphery of the through hole is turn out and enlarged. As a result, the use life of the oil seal mounted in the front cover in accordance with the present invention is lengthened.

Further benefits and advantages of the present invention will become apparent after a careful reading of the detailed description with appropriate reference to the accompanying drawings.

### BRIEF DESCRIPTION OF THE DRAWINGS

FIG. 1 is a perspective schematic view of a front cover of a manual rotary pump in accordance with the present invention;

FIG. 2 is an exploded perspective view of the manual rotary pump in FIG. 1;

FIG. 3 is a cross-sectional view of the manual rotary pump in FIG. 1;

FIG. 4 is an operational view of the front cover of a manual rotary pump in accordance with the present invention;

FIG. 5 is a perspective view of a manual rotary pump with a conventional front cover in accordance with the prior art;

FIG. 6 is an exploded perspective view of the manual rotary pump in FIG. 5;

FIG. 7 is a cross-sectional view of the manual rotary pump in FIG. 5; and

FIG. 8 is a partially enlarged view of FIG. 7.

### DETAILED DESCRIPTION OF THE INVENTION

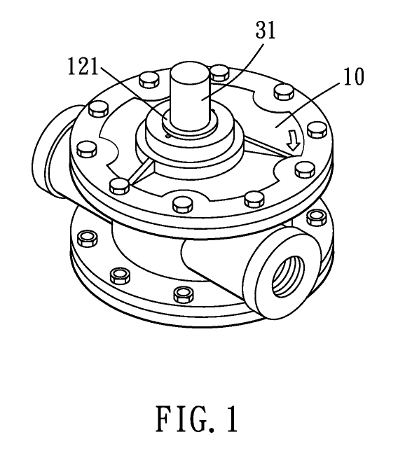

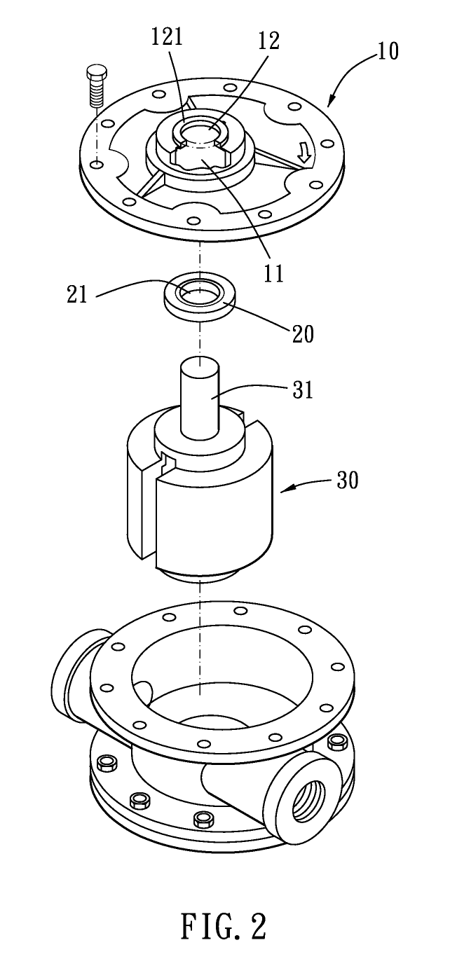

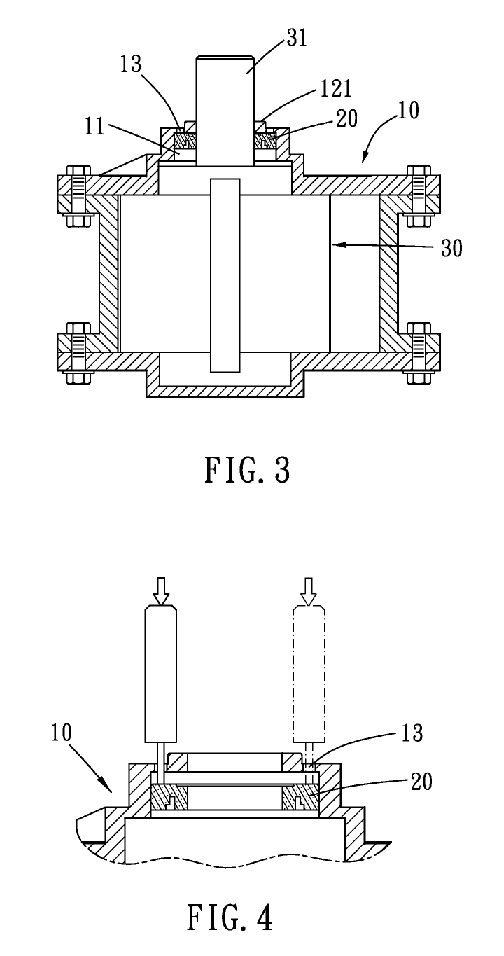

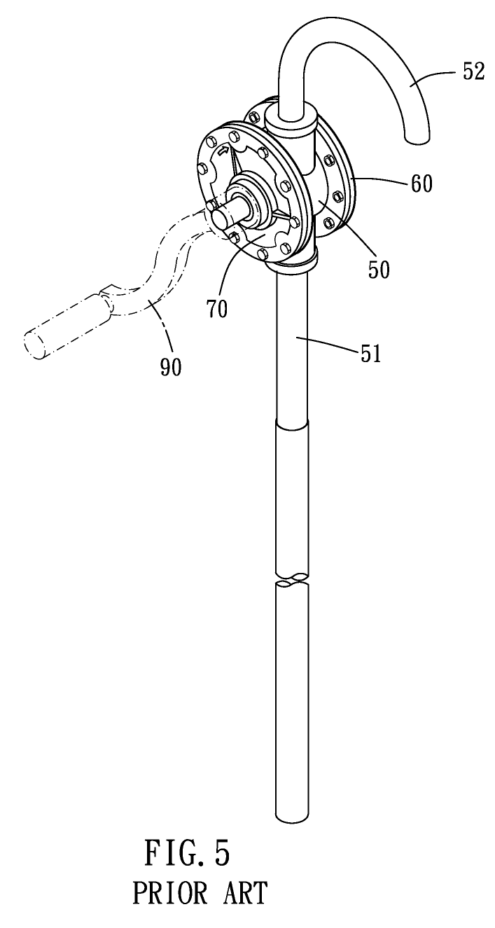

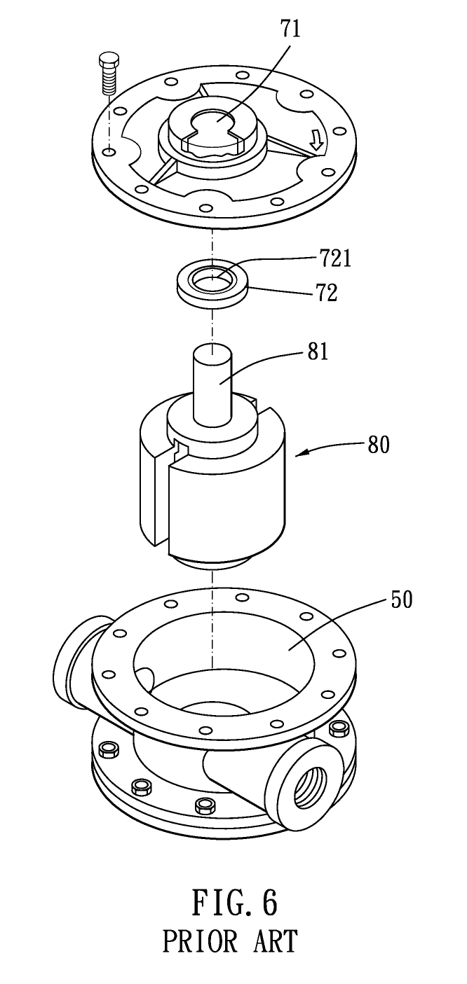

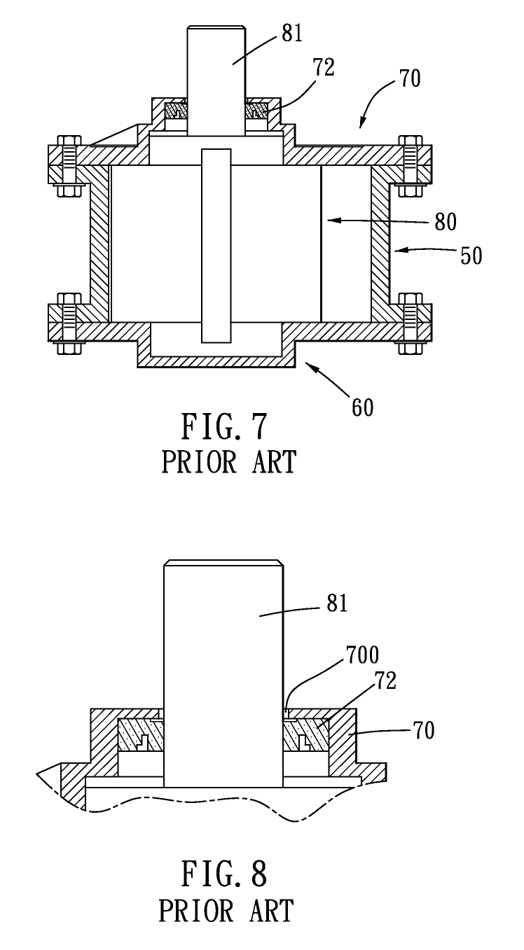

The present invention relates to a front cover of a manual rotary pump such that the appearance and the inner structure of the manual rotary pump with the present invention are similar to that of the manual rotary that has been described in the Description of Related Art. Consequently, only the front cover is described in the DETAILED DESCRIPTION OF THE INVENTION. Referring to the drawings and initially to FIGS. 1 and 2, a front cover of a manual rotary pump in accordance with the present invention comprises disk (10) having a cavity (11) eccentrically defined in an inner side thereof for airtightly receiving an oil seal (20). The cavity (11) includes a bottom having a through hole (12) defined therein to allow an input shaft (31) of a rotor (30) extending through the disk (10). The oil seal (20) is airtightly sleeved on the input shaft (31) for forming an airtight condition between the input shaft (31) and the disk (10). An annular protrusion (121) extends from the disk (10) surrounding the through hole (12) in the disk (10) for raising the operating area between the input shaft (31) and the disk (10).

In the present invention, the diameter of the through hole (12) in the disk (10) is slightly greater than that of the input shaft (31) and the diameter difference between the through hole (12) and the input shaft (31) is ranged from 0.05 mm to 0.2 mm such that an annular interval is formed between the input shaft (31) and the periphery of the through hole (12) after the manual rotary pump being assembled and the interval is ranged from 0.025 mm to 0.1 mm. The non-directional pressure from the shaken input shaft (31) forces the inner periphery of the through hole (12) in the disk (10) because the interval between the input shaft (31) and the inner periphery of the through hole (12) is slight. Consequently, the non-directional pressure from the shaken input shaft (31) never forces the oil seal (20) till the inner periphery of the through hole (12) is turn out and enlarged. As a result, the use life of the oil seal (20) mounted in the front cover in accordance with the present invention is lengthened.

The followed Table 1 is provided to show an operational comparison by water between the conventional front cover and the current front cover of the present invention.

TABLE 1

| | | Total | Total | |
|---|---|---|---|---|
| | | Operating | Pumping | |
| | Interval | Time | Quantity | Result |
| Conventional | 0.75~1.25 mm | 10 hours | 3000 gallon | Leakage |
| Front Cover | | | | |
| Current | 0.025~0.1 mm | 25 hours | 7500 gallon | Non-leakage |
| Front Cover | | | | |

By viewing the table 1, the front cover in accordance with the present invention undoubtedly can lengthen the use life of the oil seal (20) at least 2.5 times.

As described above, the diameter of the through hole (12) is slightly greater than that of the central hole (21) in the oil seal (20) such that it is difficult to detach the oil seal (20) by using the method that is described in the Description of Related Art. For operator to easily detach and replace the oil seal (20) that is mounted in the front cover in accordance with the present invention, the disk (10) has at least two bores (13) defined therein and longitudinally communicating with the cavity (11). Consequently, the operator can use a tool extending through the bores (13) to push the oil seal (20) and make the oil seal (20) separated from the cavity (11). In the preferred embodiment of the present invention, there are two bores (13) defined in the disk (10) and the two bores (13) diametrically correspond to each other relative to the diameter of the through hole (12).

Although the invention has been explained in relation to its preferred embodiment, it is to be understood that many other possible modifications and variations can be made without departing from the spirit and scope of the invention as hereinafter claimed.

What is claimed is:

1. A front cover of a manual rotary pump, comprising a disk having a cavity eccentrically defined in an inner side thereof for airtightly receiving an oil seal, the cavity including a bottom having a through hole defined therein and adapted to allow an input shaft of a rotor extending through the disk, the oil seal adapted to be airtightly sleeved on the input shaft for forming an airtight condition between the input shaft and the disk, the disk having at least two bores defined therein and longitudinally communicating with the cavity for operator to easily detach and replace the oil seal by using a tool extending through the at least two bores, wherein a diameter of the through hole in the disk is slightly greater than that of the input shaft and the diameter difference between the through hole and the input shaft is ranged from 0.05 mm to 0.2 mm.

2. The front cover as claimed in claim 1, wherein the disk includes an annular protrusion extending therefrom the disk and surrounding the through hole in the disk for raising an operating area between the input shaft and the disk.

3. The front cover as claimed in claim 1, wherein there are two bores defined in the disk and the two bores diametrically correspond to each other relative to the diameter of the through hole.

4. The front cover as claimed in claim 2, wherein there are two bores defined in the disk and the two bores diametrically correspond to each other relative to the diameter of the through hole.
